(19) United States
(12) Patent Application Publication
(10) Pub. No.: US 2007/0185729 A1
(43) Pub. Date: Aug. 9, 2007

(54) System for negotiating green tags or fixed price energy contracts

(76) Inventor: Charles A. Segerman, Silver Spring, MD (US)

Correspondence Address: Mitchell B. Wasson, Esq.;Hoffman, Wasson & Gitler, P.C., Suite 522, 2461 South Clark Street, Arlington, VA, 22202, US

(21) Appl. No.: 11/702,089

(22) Filed: Feb. 5, 2007

Related U.S. Application Data
(60) Provisional application No. 60/765,197, filed on Feb. 6, 2006.

(51) Int. Cl. G06Q 10/00

(52) U.S. Cl. 705/1

(57) ABSTRACT

The present invention describes a method for encouraging the production and use of electricity from renewable energy sources. A clearing house is established for facilitating various agreements and contracts between green power generators, electricity utilities and electricity end users. A computer model would be employed to help produce fixed costs or essentially fixed costs contracts between the green power generators, the electricity utilities and the electricity end users. Additionally, renewable energy certificates can be bought and sold to either maximize profits or reduce the costs of the electricity.

### CROSS-REFERENCE APPLICATION

The present application is based upon U.S. provisional patent application Ser. No. 60/765,197, filed on Feb. 6, 2006. The contents of this application is explicitly incorporated by reference.

### FIELD OF THE INVENTION

The present invention is directed to a method for negotiating and/or procuring contracts between an energy producer, particularly a green energy producer and an end user or a green energy producer and a utility.

### BACKGROUND OF THE INVENTION

Most analysts of the energy industry have advocated for a long period of time that our heavy reliance on non-renewable energy sources is presently a detriment to the economic well-being of our increasingly technological society. As can be appreciated, fossil fuel sources such as natural gas, petroleum and coal are being depleted at an alarming rate. The finite amount of these fossil fuel sources results in an increasingly higher and volatile cost of the fossil fuel sources on the open marketplace. Additionally, as these sources are depleted, the search for the location of additional fossil fuel sources is being undertaken in environmentally sensitive areas. This is important since recently, more and more areas of our globe have increasingly developed the capacity to utilize and need sources of energy. These locations include the densely populated areas of India and China. This increased marketplace for fuel sources will tax this limited resource even further, and increase externalized costs which ultimately cause damage to the environment resulting in increased remediation costs and health care costs. These costs are often borne by the public citizenry.

Just as alarming as the increased cost of producing energy generated from fossil fuel sources, is the deleterious effect that the burning of these fossil fuel sources has on the environment. The utilization of these fossil fuel sources will produce carbon dioxide emissions which are increasingly trapped in the atmosphere, creating the “greenhouse effect” of global warming. In fact, a recent study conducted by NASA came to the conclusion that if the emissions causing the greenhouse effect were not greatly reduced and kept at a minimum, the summer ice cap at the North Pole would be totally eliminated in approximately 40 years, resulting in a rising sea level creating disastrous effects on coastal communities, such as New Orleans and southern Florida. In fact, President Bush in his recent State of the Union Address proposed reducing gasoline consumption in the United States by 20% in the next ten years. Furthermore, President Bush commented that the problem of global warming must finally be addressed.

There presently exists a number of renewable energy sources which should be more fully developed and utilized to be used as a substitute for fossil fuel. The employment of these renewable energy sources would lessen our reliance on the limited supply of fossil fuel in the earth as well as decreasing the carbon dioxide emissions which result in global warming. These renewable energy sources include, for example, solar energy, wind energy, small/low-impact hydroelectric energy, geothermal energy, organic bioenergy, biomass energy, landfill gas and tidal energy. Therefore, a method should be devised for encouraging the use of these renewable energy sources.

### SUMMARY OF THE INVENTION

The deficiencies of the prior art are overcome by a method for providing cost effective processes to use renewable energy sources such as solar, wind, small/low-impact hydroelectric energy, geothermal energy, organic bioenergy, biomass energy, landfill gas and tidal energy. Since various end users of electricity would like to utilize an “environmentally friendly” electricity supplier, various energy distributors, such as national, regional and local utilities would like to promote the fact that they use at least some renewable energy sources. One manner to advertise this use would be to acquire a renewable energy certificate (REC). The REC represents all of the environmental attributes which are created when electricity is generated using renewable resources instead of using fossil fuel sources such as coal, oil and natural gas. A purchaser, such as a company, an utility, or even an electricity end-user would acquire the REC, also commonly known as a “green tag”. An entity, such as a clearing house would identify and track green power generators as well as these marketable RECs. This information would be provided on a computer, thereby allowing the entity to be cognizant of all of the generated RECs whether they are currently on the market or not. In many instances, a regional transmission organization (RTO) or independent system operation (ISO) would be in possession of a relatively expensive REC. The entity or clearing house would facilitate the RTO or ISO in the purchase of less expensive RECs associated with green energy from a green energy provider located in other areas of the United States where the cost to generate green energy is less expensive, thus enabling the purchaser of the REC to continue to operate as well as market and advertise to the public that the company's energy usage is still “green”, but for less money, thereby “netting down” or reducing the cost for their customers to market their energy usage as green. The national market would receive the regional RECs and return the nation RECs in an equivalent amount of kilowatt hours.

A second attribute of the present invention would allow the clearing house to obtain and negotiate a “fixed price” energy product primarily utilizing the renewable energy sources previously listed. End users, or a local utility and its customers would benefit if the cost of supplying energy would be fixed for a certain period of time. The clearing house would utilize a computer model to track the various green energy producers as well as obtain information relating to the various national, regional and local utilities. The entity would facilitate various contracts or power purchase agreements (PPAs) between the various electricity utilities and the green power generators as well as to facilitate contracts with end users and utilities. The advantage to the green energy generators would be locking in at a fixed price (often at a reduced rate) for the commitment of an utility to purchase a substantial amount of the green energy generators output for a defined period of time, such as five years or more. The attribute of relatively long-term fixed price contract provides a commitment by a utility or end user to purchase the green power generator's output. This financial commitment can be taken to financiers who are willing to loan development funds based on the commitment, resulting in an increase in the number of clean kilowatt hours being developed and generated. Utilizing wind power as an example, a fixed-price product is available because the turbine generator is a fixed price (the cost to purchase equipment), the installation is a known number, and the cost to maintain the turbine generator and other required equipment can be quantified. It is important to note that the cost of the fuel source to run the turbine generator would be zero. Furthermore, the cost of transmitting the energy from the green energy generator to the national, regional and local utilities is known as is the tax and other system incidentals.

The national, regional and local utilities would benefit by these contractual arrangements since the utility can now provide electricity from low cost electricity generators to the end users because the resource for the energy generator is free, yet the utility does have the opportunity to employ non-renewable energy sources as a back-up, if a problem occurs in supplying its customers with electrical energy from strictly the green energy generators.

If, for example, the green energy generator is under performing on a given date, the utility can arrange for the contracted energy requirements of its customers from another source, such as gas or coal. However, the need to supply end users the more costly commodities will be reduced to a relatively low number of unpredictable days as opposed to the present state which is daily reliance. Experience has shown that the end users, such as the distributors as well as the customers, are comfortable purchasing their power, whether non-renewable or renewable when they can be assured of an uninterrupted flow of power.

Although this scenario was described with the use of wind to generate electricity, the same fixed price concept would work for other types of renewable energy sources, such as solar panels (photo-voltaic), small/low-impact hydroelectric production, geothermal energy, organic bioenergy, biomass energy, landfill gas and tidal energy.

The present invention would establish a system providing energy to the end user, such as a distributor of a customer at a fixed or known cost. This is contradistinction to the traditional method of supplying energy to an end user at an unknown cost. This fixed cost could conceivably save utilities billions of dollars as well as publicizing the fact that they are environmentally friendly through the utilization of renewable energy sources. The saved costs would include the cost of hedges, hedge products, reserves and factors of safety to name a few. Once the price of energy/electricity is known, more accurate budgeting, forecasting and better decision making with respect to maintenance and purchasing can be made, thereby saving the utilities a considerable amount of money. A decision whether or not to rehabilitate existing equipment or purchase new equipment can easily be made when the price of energy/electricity is known with a high degree of certainty. Purchasing decisions regarding the level of quality can be more informed when energy prices are known. Payback will be more accurate, therefore giving companies higher economic returns on their decisions.

A variation of the “fixed price” method would be to utilize a “essentially fixed price” method. Although the costs of generating electricity as well as the cost of transmitting and distributing this electricity to the end users, including customers are generally known, various conditions, outside of the control of the energy producers as well as the distributors would, in theory, increase the price of the energy to the end users. In this situation, the national, regional and local utilities may wish to reserve the right to increase their price. The conditions outside of the control of the utilities are items that can be identified by name but are subject to change, especially if the contract period for the fixed-price product is for a period longer than five years. However, since all of these conditions can be pegged to establish various price indices, the end user would be assured that the utility is not manipulating the market to produce a higher profit. This would assure the end user that no additional profit will be required over the length of the contract. Any regulatory change would be treated as a pass-through by the utility. Because this regulatory change would affect every consumer whether or not contracts are in place, there is no additional profit to the utility. The energy and service fees remain fixed, all line items that make up the ultimate price are either fixed or locked in and are subject to increase only if the regulatory change occurs and that regulatory change can be verified by the respective utility commission. This would give the end user a degree of confidence needed that the energy/electricity cost will remain essentially stable throughout the contract period.

Another embodiment of the present invention would combine the “fixed price” or “essentially fixed price” with the “net down” method as previously explained. This would provide green energy to the end user at a competitive brown energy price. Once the clearing house has gathered all relevant information regarding the green energy generators, the various utilities, the various RECs that have issued and/or are currently on the market, a computer model would be generated, facilitating the negotiations between the energy producers and the energy distributors. Once the appropriate bundled energy contracts are established, the proceeds from the sale of a relatively expensive REC components of the bundled energy contract can be used to by less expensive RECs, thereby “netting down” the energy costs while still being “green”.

### BRIEF DESCRIPTION OF THE DRAWINGS

For a fuller understanding of the nature and objects of the present invention, reference should now be made to the following detailed description taken in connection with the accompanying drawings in which the same reference numerals are used to indicate the same or similar part wherein:

FIG. 1 is a graphical description of the energy flow between the energy producers, the energy distributors and the end user;

FIG. 2 is a graphical representation of the contractual relationships between the energy producers, the distributors and the end users;

FIG. 3 is a graphical description of the benefits of the present invention;

FIG. 4 is a graph illustrating the potential monetary savings generated by the use of the present invention;

FIG. 5 is a block diagram showing the method of a first embodiment of the present invention;

FIG. 6 is a block diagram showing the method of a second embodiment of the present invention; and

FIG. 7 is a block diagram showing the method of a third embodiment of the present invention.

### DETAILED DESCRIPTION OF THE PREFERRED EMBODIMENTS

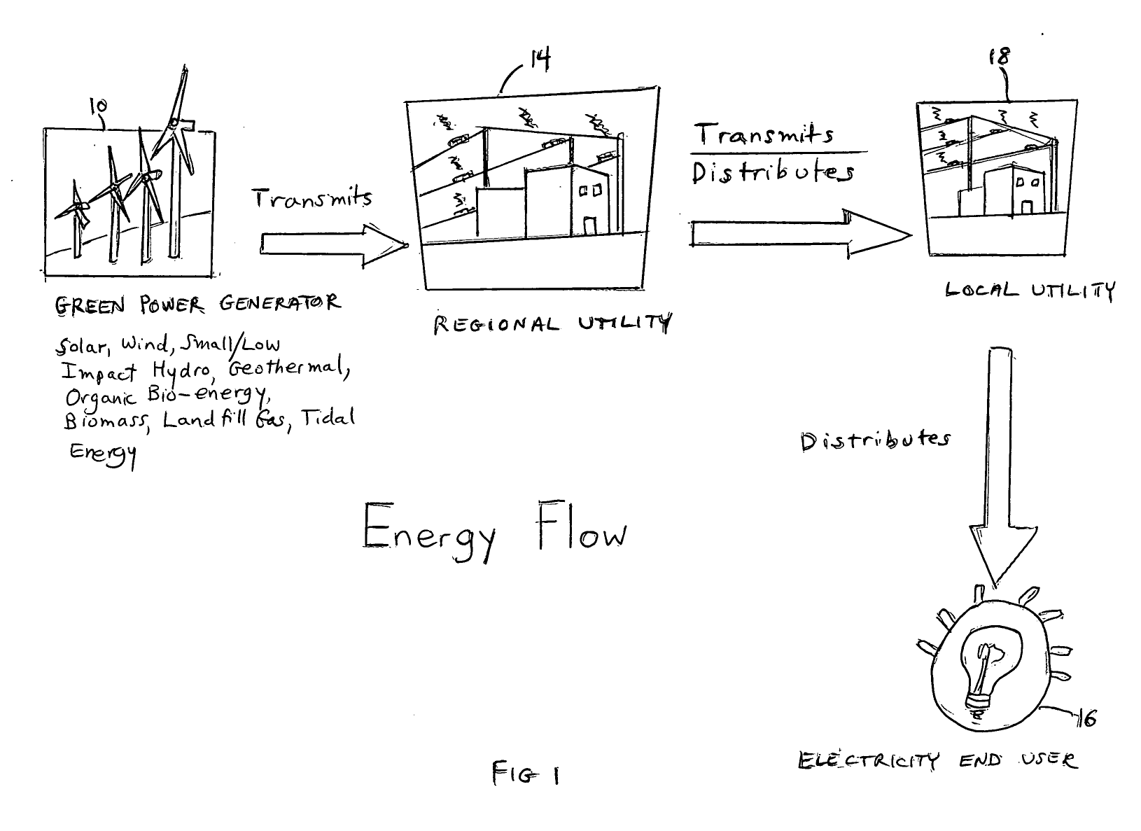

FIG. 1 describes the manner in which electricity is produced and then distributed to the user of the electricity. A green power generator 10, such as producing electricity using solar power, wind power, small/low impact hydroelectric power, geothermal energy, organic bio-energy, biomass, landfill gas and tidal energy would transmit this energy to a national or regional utility 14 which would then transmit and distribute this electrical power to a local utility 18. It is noted that the number of utilities in the chain are dependent upon the region and the end user 16 of the energy. Therefore, a national utility might not be included and the local utility may or may not be required depending on the region. If the local utility 14 is not required, then the regional utility will transmit and distribute electricity to the end user 16.

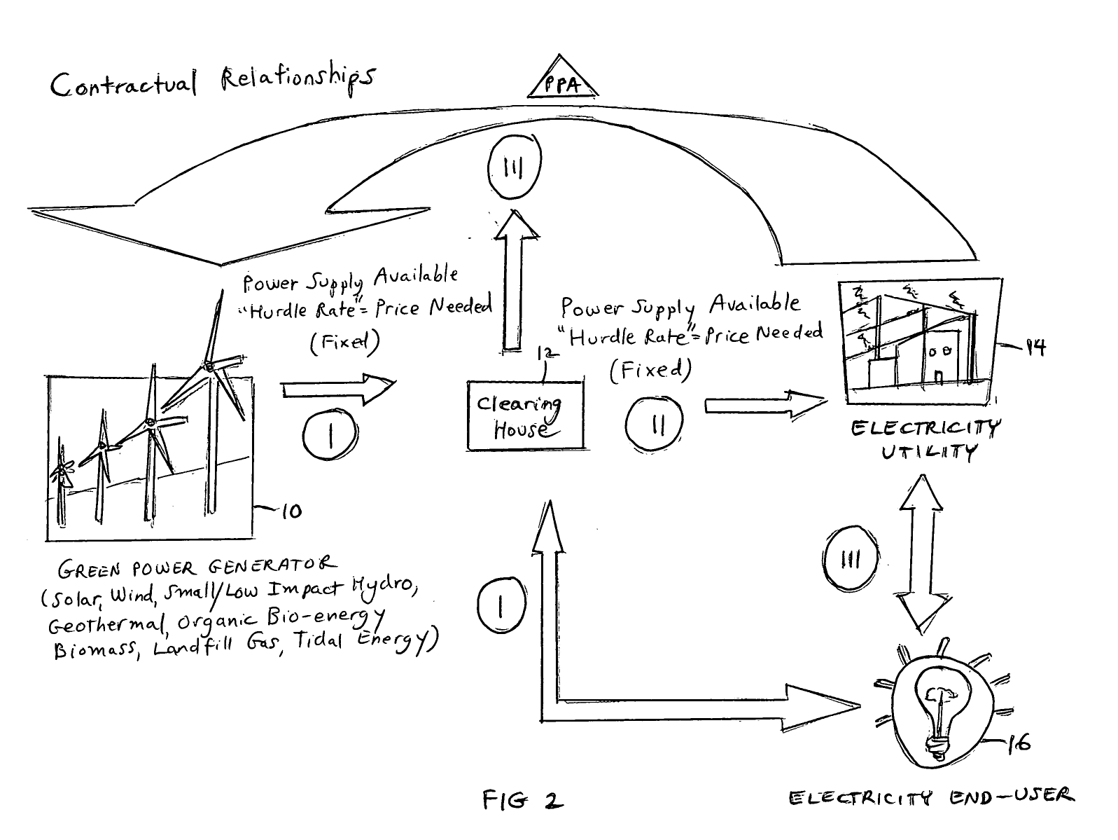

FIG. 2 illustrates the contractual relationship created and negotiated by a clearing house 12. These contracts are facilitated by the clearing house 12 and are provided between the green power generator 10, the electricity utility 14 and the end user 16. The clearing house 12 is provided with a computer and a computer model which contains information relating to the green power generators 10. This information would include the various parameters needed to determine the cost of producing the particular green power generated by the green power generator 10. Information relating to the transmission and distribution of the electricity from a national, regional or local utility 14, 18 would also be included in the computer at the clearing house 12. The computer would also contain information relating to the end user 16. The information provided to the computer would also contain information relating to the various RECs which have been generated and their market value. The clearing house would utilize this information to the price of $10 per megawatt, then the end user must pay the green energy generator, through the utilities 14, 18 or directly $80 per megawatt. However, if the end user sells the regional RECs for $15 per megawatt on the open market and buys a different REC that is still 100% green for $3 per megawatt, then the end user would pay $68 per megawatt, and still be supplied with 100% green energy.

If the negotiated price is fixed or essentially fixed, the costs associated with hedging can be eliminated. Further costs can be saved by combining the benefits of the fixed price or essentially fixed price bundled energy products with the “net down” strategy. In a volatile commodity market, like fuel, it is likely that after a number of years, a cost savings will be realized merely from the forethought of previously buying energy at the previous market rate, or even at a slightly higher initial rate and then locking in the cost of energy for a period of time. The cost of the green energy would become less than non-renewable energy products such as oil, coal and natural gas. In this instance, the selling of the regional RECs from the green energy generator would create a profit to the end user. It is then up to the end user to determine whether it wants to remain green by buying cheaper RECs or maximizing its profit by selling their green attributes entirely. Thus, the end user can reduce its energy costs by locking in an energy price from an energy source that happens to be green while also having the potential profit from the arbitrage or sale of the RECs issued from the green power generator 10. In the previous example, the end user could maximize its bottom line if it does not purchase an additional REC and merely sells its REC for $15 per megawatt. In this instance, the end user 16 would “net down” the end user cost to $65 per megawatt hour.

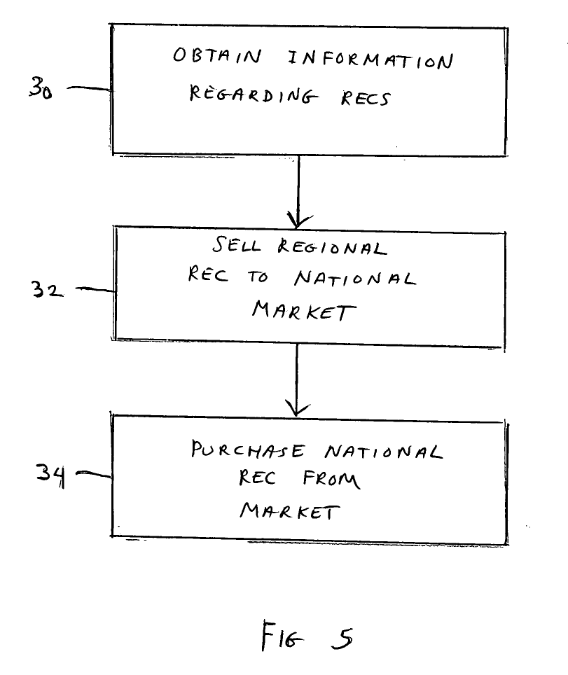

FIG. 5 illustrates a block diagram enumerating the various steps of the method according to the first embodiment of the present invention. The clearing house 12 would obtain facilitate a contract, such as a power purchase agreement (PPA) with the green power generator 10 and the electricity utility 14. The clearing house 12 would also facilitate a contract between the electricity utility 14 and the electricity end user 16. These contracts are facilitated by the clearing house 12 using a computer model to identify the electricity end users 16 by analyzing power needs and prices that they are willing to pay. The electricity generated by the green power generator 10 which would be transmitted to a regional utility 14 which is a part of the national energy grid. The regional utility 14 would then distribute and transmit the energy contracted by a local utility 18 which could be the end user 16. Via the aforementioned power purchase agreement to the regional or local utility which would have a contract with an electricity end user such as a customer or a distributor 16, to supply the electricity needs of the end user.

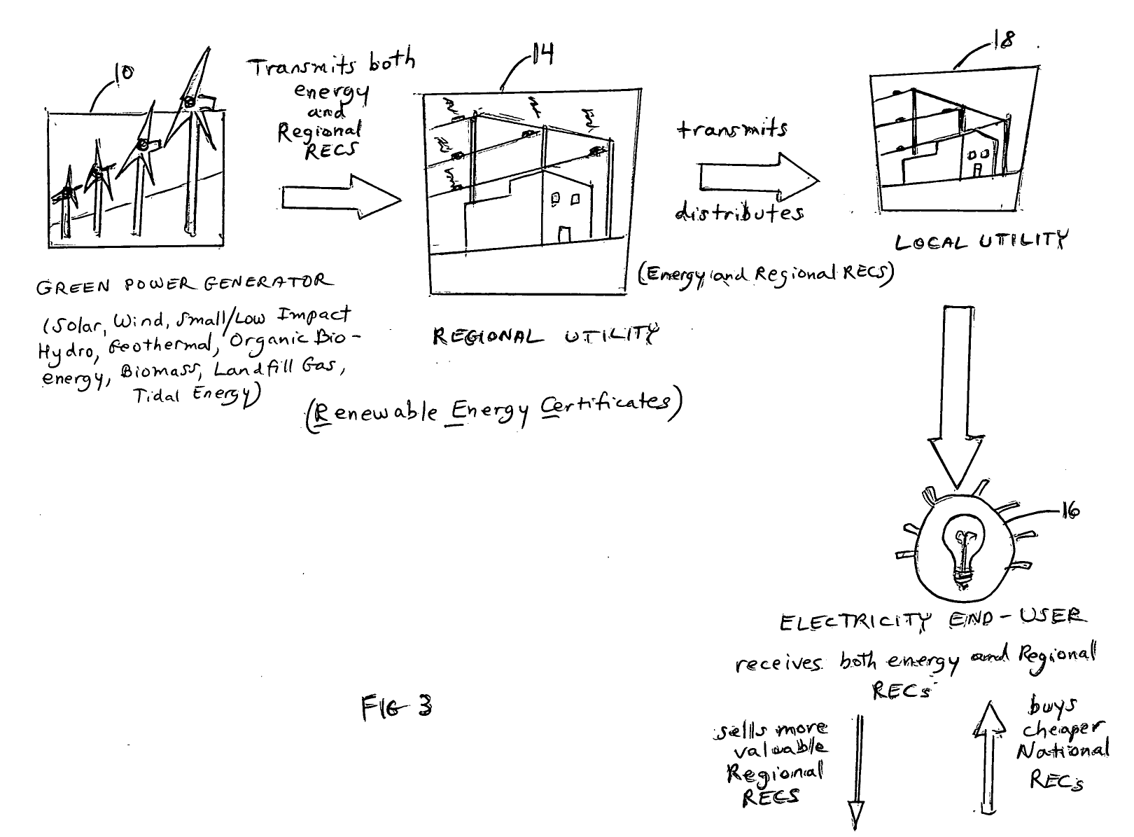

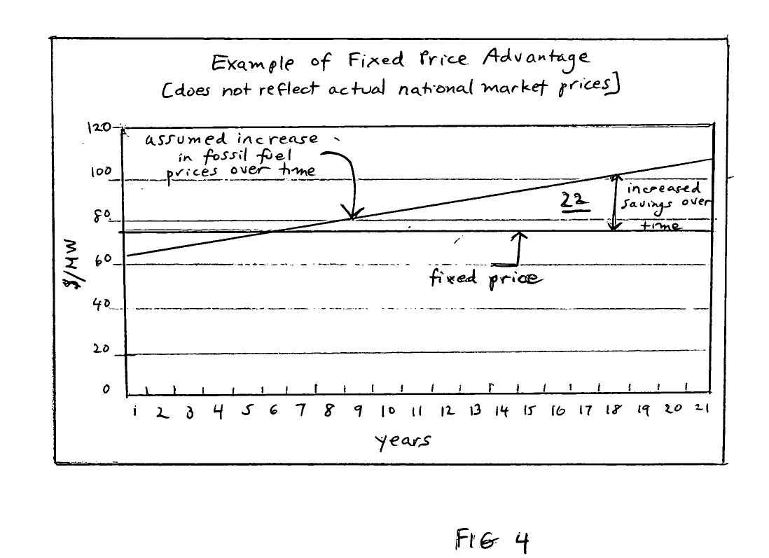

FIG. 3 shows the benefit of contracting energy at a fixed price for a relatively long term. In this context, even the payment of a slight premium in the early years of a contract such as shown in the graph of FIG. 4 would result in an overall savings over time. This cost benefit can be calculated utilizing the area 22 under the line entitled Assumed Increase in Fossil Fuel Prices Over Time and the horizontal line. FIG. 4 also indicates that along with the energy, the regional RECs would flow to the electricity end user who could sell these more valuable regional RECs to purchase less expensive national RECs. The sale or exchange of these RECs could result in a lessened cost to the end user 16, while still assuring the end user that a green energy source was utilized.

For example, if the end user 16 negotiates a term contract where it purchases a bundled energy product for $70 per megawatt and the energy's green attributes, RECs, are contracted at information relating to the various green power generators 10, the various electricity utilities 14 as well as identifying end users 16 and analyzing the power capabilities and power needs of each of the constituents. This information would then be provided in a computer which would also include information regarding the various RECs at step 30. The information would be processed in the computer and would facilitate the electricity end user 16 to sell various valuable regional RECs to the national market at step 32 and then to purchase, if desired, less expensive RECs from the national market at step 34.

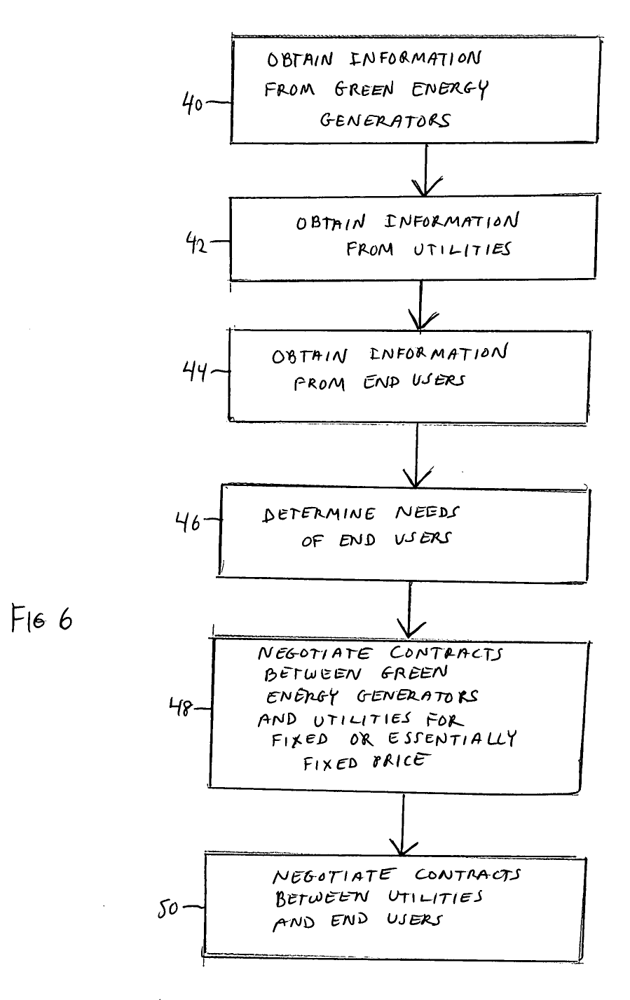

Additionally, the clearing house would be able to facilitate the various contracts between the green power generators, the electricity utilities and the end users. This is illustrated in FIG. 6 in which, as previously indicated, information from the green energy generators is obtained and entered into the clearing house's computer at step 40. Step 42 indicates that information is obtained from utilities and from the end user's at step 44. The needs of the end users are determined at step 46 and contracts are negotiated between the green energy generators, the utilities for a fixed or essentially fixed price at step 48. The clearing house 12 would then negotiate contracts between the utilities and the end users at step 50.

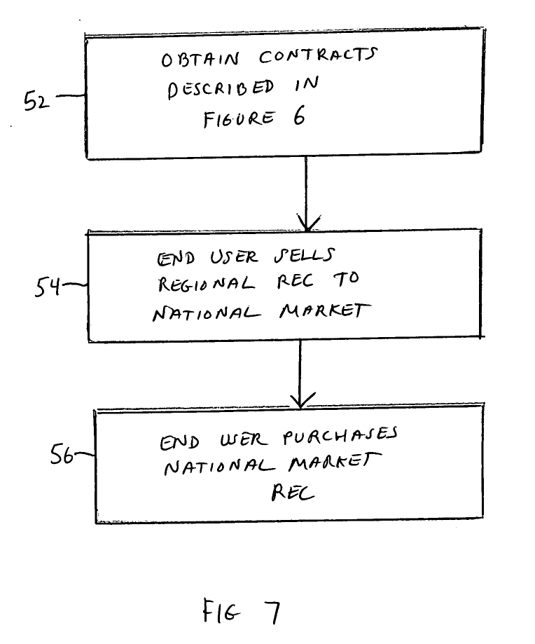

FIG. 7 illustrates the situation in which the “net down” strategy is combined with producing a fixed price or essentially fixed price contract. Once the appropriate contract illustrated in FIG. 6 at step 52 are obtained, the end user, with or without the assistance of the clearing house 12 would assist the end user 16 in selling regional RECs to the national market at step 54. Generally, these regional RECs are more costly than other RECs. At this point, if the end user wishes to be completely “green”, an REC would be purchased on the national market at step 56. However, if the end user is satisfied with receiving at least a portion of his electricity needs produced by non-renewable sources, the end user's savings could be further maximized.

Since certain changes may be foreseen in the aforementioned methods without departing from the scope of the invention hereinabove, it is intended that all matter contained in the above description are shown in the accompanying drawings shall be interpreted in an illustrative and not a limiting sense.

What is claimed is:

1. A computer implemented method for negotiating contracts between renewable energy suppliers, energy distributors, and energy end users, including the steps of:
creating a computer model for facilitating negotiating between the renewable energy supplier and the energy distributors;
obtaining first information from renewable energy suppliers including the types of energy provided and the cost of producing the energy;
entering said first information in a computer;
obtaining second information from the renewable energy distributors and end users relating to the distribution of energy to end users;
entering said second information into said computer;
obtaining third information relating to regional renewable energy certificates;
entering said third information into said computer;
negotiating agreements between the energy suppliers and the energy distributors as well as between the energy distributors and end users, said agreements including the purchase and sale of renewable energy certificates.

2. The method in accordance with claim 1, wherein the renewable energy suppliers supply electricity.

3. The method in accordance with claim 2 further including a fixed cost of the supply of said electricity in said agreements.

4. A computer implemented method for negotiating contracts between renewable energy suppliers, energy distributors, and energy end users, including the steps of:
creating a computer model for facilitating negotiating between the renewable energy supplier and the energy distributors;
obtaining first information from renewable energy suppliers including the types of energy provided and the cost of producing the energy;
entering said first information in a computer;
obtaining second information from the renewable energy distributors and end users relating to the distribution of energy to end users;
entering said second information into said computer; obtaining third information relating to regional renewable energy certificates;
negotiating agreements between the energy suppliers and the energy distributors as well as between the energy distributors and end users, said agreements including the purchase and sale of the energy at a fixed cost.

5. The method in accordance with claim 4, wherein the renewable energy suppliers supply electricity.

6. The method in accordance with claim 4, further including the steps of:
said end users obtaining a regional renewable energy certificate; and
selling said regional renewable energy certificate on the open market.

7. The method in accordance with claim 5, further including the steps of:
said end users obtaining a regional renewable energy certificate; and
selling said regional renewable energy certificate on the open market.

8. The method in accordance with claim 6, further including the step of purchasing a national renewable energy certificate on the open market at a cost less than the sale price of said regional renewable energy certificate.

9. The method in accordance with claim 7, further including the step of purchasing a national renewable energy certificate on the open market at a cost less than the sale price of said regional renewable energy certificate.

10. A computer implemented method for negotiating contracts between renewable energy suppliers, energy distributors, and energy end users, including the steps of:
creating a computer model for facilitating negotiating between the renewable energy supplier and the energy distributors;
obtaining first information from renewable energy suppliers including the types of energy provided and the cost of producing the energy;
entering said first information in a computer;
obtaining second information from the renewable energy distributors and end users relating to the distribution of energy to end users;
entering said second information into said computer;
obtaining third information relating to regional renewable energy certificates;
entering said third information into said computer;
negotiating agreements between the energy suppliers and the energy distributors as well as between the energy distributors and end users, said agreements including the purchase and sale of national and regional renewable energy certificates; and
selling a regional renewable energy certificate obtained by said end user.

11. The method in accordance with claim 10, wherein the renewable energy suppliers supply electricity.

12. The method in accordance with claim 10, further including the step of purchasing a national renewable energy certificate at a cost less than the sale price of said regional renewable energy certificate.
